(19) United States
(12) Patent Application Publication
(10) Pub. No.: US 2021/0377422 A1
(43) Pub. Date: Dec. 2, 2021

(54) VISUALLY SIGNIFICANT MARKING SCHEMES

(71) Applicant: Hewlett-Packard Development Company, L.P., Spring, TX (US)

(72) Inventors: Robert Ulichney, Stow, MA (US); Matthew D. Gaubatz, Seattle, WA (US); Stephen Pollard, Bristol (GB)

(73) Assignee: Hewlett-Packard Development Company, L.P., Spring, TX (US)

(21) Appl. No.: 16/963,323

(22) PCT Filed: Mar. 20, 2018
(86) PCT No.: PCT/US2018/023300

§ 371 Date: Jul. 20, 2020

(51) Int. Cl. H04N 1/405; G06K 19/06; H04N 1/00

(52) U.S. Cl. CPC H04N 1/4055; H04N 1/00761; G06K 19/06037

(57) ABSTRACT

In an example method, a visually significant marking scheme is generated including a pattern of data marks and reference marks based on a received image to be printed, data information, and reference information. Data marks are generated based on the data information and the reference marks are generated based on the reference information. The image is printed including the data marks and the reference marks arranged based on the visually significant marking scheme onto the surface of the object.

### BACKGROUND

Marking schemes may be used to embed data into documents using patterns of symbols such as dots. For example, the symbols may be used to embed data such as information about a printer, a date, time of printing, and the like.

### BRIEF DESCRIPTION OF THE DRAWINGS

Various features of the techniques of the present application will become apparent from the following description of examples, given by way of example only, which is made with reference to the accompanying drawings, of which:

FIG. 1 is a drawing of an example visually significant marking scheme having a diagonally symmetric pattern;

FIG. 2A is a drawing of an example of a visually significant marking scheme having a vertically striped pattern revealing orientation between the two cardinal directions;

FIG. 2B is a drawing of an example of a visually significant marking scheme having a diagonally striped pattern revealing orientation between the two cardinal directions;

FIG. 3A is a drawing of an example of a visually significant marking scheme having a mixed pattern revealing a more detailed orientation;

FIG. 3B is a drawing of another example of a visually significant marking scheme having a differently mixed pattern revealing a more detailed orientation;

FIG. 4 is a drawing of an example of a visually significant marking scheme having a capacity-preserving pattern;

FIG. 5A is a drawing of an example of a data dot pattern with embedded data to be arranged according to a visually significant marking scheme;

FIG. 5B is a drawing of an example of a modulated dot pattern positioned according to a visually significant marking scheme;

FIG. 5C is a drawing of an example of a vertically oriented dot pattern arranged according to a visually significant marking scheme having an orientation-revealing pattern that is vertically striped;

FIG. 5D is a drawing of an example of a mix modulated dot pattern arranged according to a visually significant marking scheme having a more detailed orientation-revealing mixed pattern;

FIG. 5E is a drawing of an example of a capacity-preserving dot pattern arranged according to a visually significant marking scheme having a capacity-preserving pattern;

FIG. 5F is a drawing of an example of a high resolution dot pattern arranged according to a visually significant marking scheme having more variation to provide higher resolution positional information;

FIG. 6A is a drawing of an example of a clustered-dot halftone with embedded data;

FIG. 6B is a drawing of an example of a modulated clustered-dot halftone arranged according to a visually significant marking scheme;

FIG. 7 is a process flow diagram illustrating an example method for printing images with reference marks based on a visually significant marking scheme;

FIG. 8 is a block diagram of an example computing device to print images with reference marks based on a visually significant marking scheme; and

FIG. 9 is a block diagram of an example machine-readable storage medium that may be used to print images with reference marks based on a visually significant marking scheme.

### DETAILED DESCRIPTION

Marking schemes with out-of-band fiducial markings may be used for alignment purposes. A marking scheme refers to a system of symbols used to convey a message, and an out-of-band fiducial marking, as used herein, refers to a marking that does not convey any part of that message, and is not integrated with the symbols conveying data information. Data information, as used herein, refers to information that is represented by the message conveyed by a marking scheme. For example, out-of-band fiducial markings may be used in QR codes and barcodes; out-of-band fiducial markings do not contain any information related to the content of the QR code, or even what it represents, but may be used to help interpret a QR code correctly. However, out-of-band markings may not be visually appealing and large in size.

Visually significant barcodes (VSBs) include marking schemes that may be embedded in visual data. However, VSBs use a sample of the image data represented by the VSM for alignment and interpretation. Thus, a reference image may be used in order to analyze extracted data information. Other approaches use reference elements to interpret positions of individual dots, but the organization of data within the design resembles that of a barcode, and orientation information may be used to interpret data. In addition, these latter approaches may be constrained to using uniform marking sizes and perturbations.

Described herein are techniques for printing images with reference marks based on a visually significant marking scheme. As used herein, a visually significant marking scheme refers to an arrangement of data marks and reference marks in a visually significant pattern such as an image. For example, the data marks and reference marks may take the form of dots or half-tone markings that form an overall visual image. The data marks may encode data information such as information about a printer, date, or time, among others. Reference marks may encode reference information. Reference information, as used herein, refers to information used to interpret the data marks, but is not part of the information represented by the data marks. The reference information may include information about a print surface. In some examples, the appearance of the reference marks used to convey reference information may be derived by varying the same property as is used to create the appearance of the data marks. For example, the modulation scheme used to map information to mark may be based on altering relative position, color, size, and the like.

The techniques described herein thus enable robust interpretation of data markings across a surface using reference marks that may not be visually intrusive and may not require more than local context to be interpreted. For example, the techniques may not use large markings such as barcodes and may not require full image registration for underlying patterns to be decodable. In addition, the techniques may be used to establish an ordering of a group of detected markings within a surface encoding scheme using the visually significant marking scheme. Moreover, the presence or absence of knowledge of such an ordering may be used to increase robustness of any system reporting on an absence, presence, or interpretation of markings encoded on a surface. Thus, the techniques may provide a natural criterion to establish the presence or absence of a marking scheme, independent of the specifics of the marking scheme. The techniques may also enable discoverable segmentation of data into groups with different localizing properties.

The techniques may also be used to separate data marks and reference marks into distinct classes to allow a surface encoding scheme to be interpreted from a low-resolution, cropped, noisy, or otherwise degraded view of the encoding. For example, only a subset of a document may have been captured using a mobile device or the document may have been processed under resource constraints, such as time or memory constraints. The techniques may be used to detect an orientation of a marking, and thus detect a position or other geometric aspects of a marking scheme that may be used to denote different states of information, such as sequences of bits.

The techniques may be used to more efficiently interpret markings by inducing an ordering on candidate markings, that is, to specify and/or to help determine a sequence in which the markings can be interpreted. In some implementations, determining the orientations of the cardinal directions of the surface may be enough to induce such an ordering. For example, if several marking orientations or angles are used to represent data, then the techniques described herein may be used to detect the cardinal directions with respect to how the angles may be defined. The detected cardinal directions may be used to limit a space of all angles to be considered when analyzing captured marks. The techniques thus enable a fast, single-pass interpretation of an image and included reference and data markings.

Moreover, the techniques may be compatible with any surface-based mechanism for representing data. The techniques may also be robust to a wide range of distortions. For example, the techniques may handle affine transformation, perspective distortions, and more general geometric warps of an underlying substrate. In addition, the visually significant marking schemes described herein enable interpretation of data information in dot patterns from low resolution scans and mobile video frames. In some examples, an encoded image may be captured via different possible imaging pipelines and the formation details of what color channels may be present or what preprocessing operations have been applied to the image may be unknown to the decoder. The techniques described herein allow for the interpretation of the encoded messages even if the formation details and preprocessing operations are unknown. The imaging pipelines may use color, monochrome, or enhanced imagery, among others. The formation details may include color channel, any color preprocessing, lighting corrections, and the like. Adding an arrangement of reference marks, including different colors, sizes, luminances, or any combinations thereof, in a manner that integrates with existing patterns of an image may provide a basis for detecting information that is lost, or is not apparent, during imaging. For example, relative differences between dots of two different known colors may reveal information regarding color channels in which an image was originally represented. Similarly, the techniques described herein can be used to identify orientations of a pattern present in mobile captured imagery of the same page.

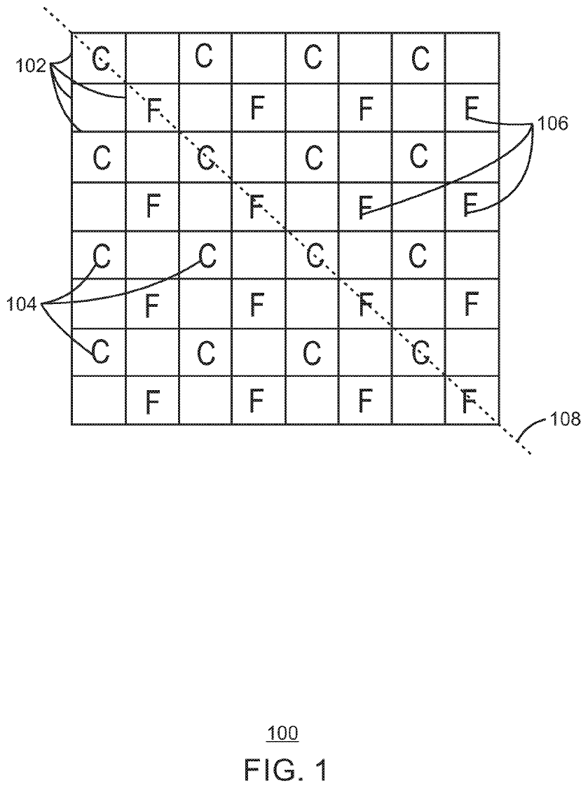

FIG. 1 is a drawing of an example visually significant marking scheme having a diagonally symmetric pattern 100. The example visually significant marking scheme having the diagonally symmetric pattern 100 may be implemented in the computing device 800 or the machine-readable storage medium 900 below.

The diagonally symmetric pattern 100 includes a number of cells 102 including data marks 104 and reference marks 106. A line of symmetry 108 is drawn across the diagonally symmetric pattern 100 indicated using a dashed line. Although included throughout the figures for purposes of illustrating relative position, the grid lines shown may not be printed when a corresponding dot pattern or half-tone cluster using a visually significant marking scheme having the diagonally symmetric pattern 100 is printed onto a surface.

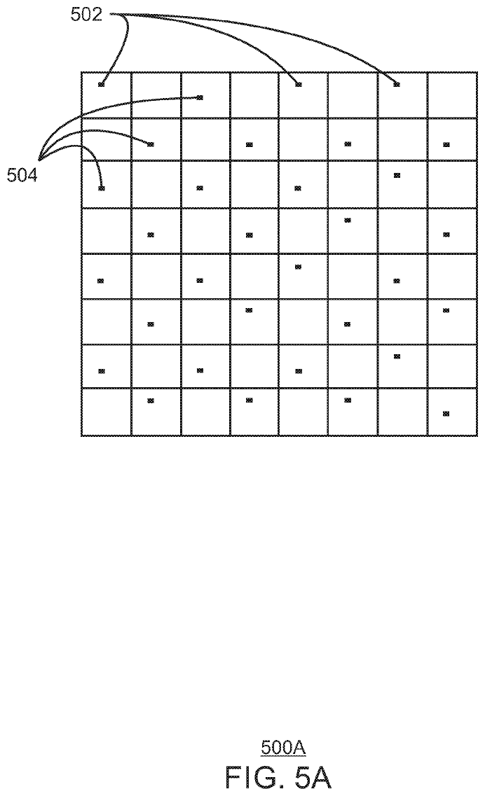

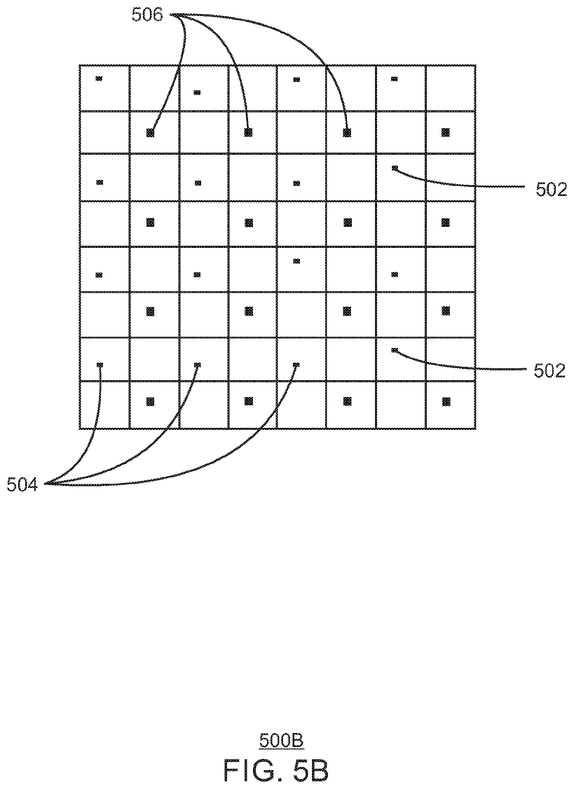

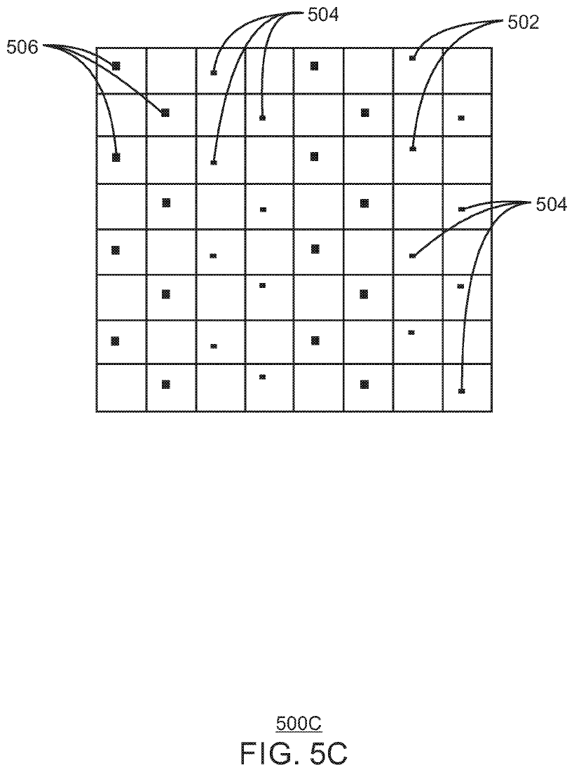

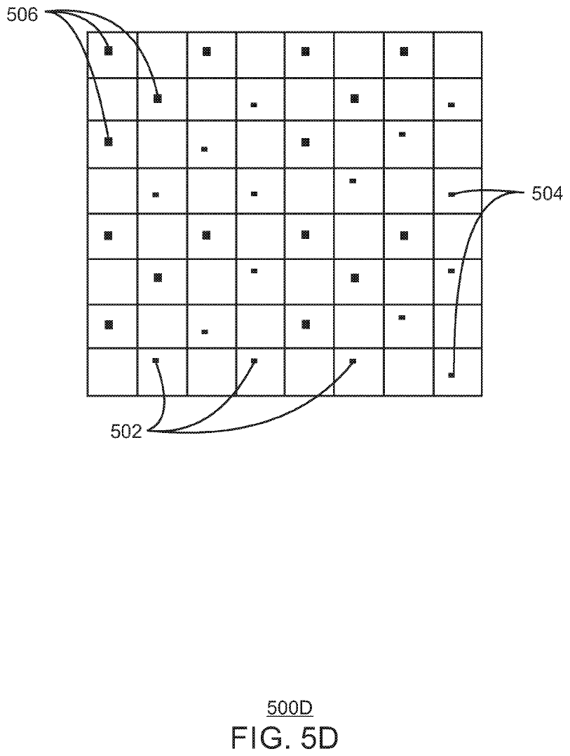

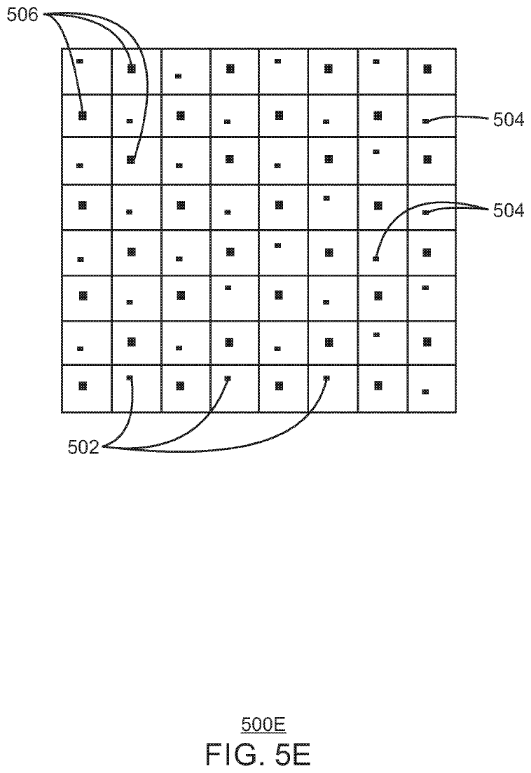

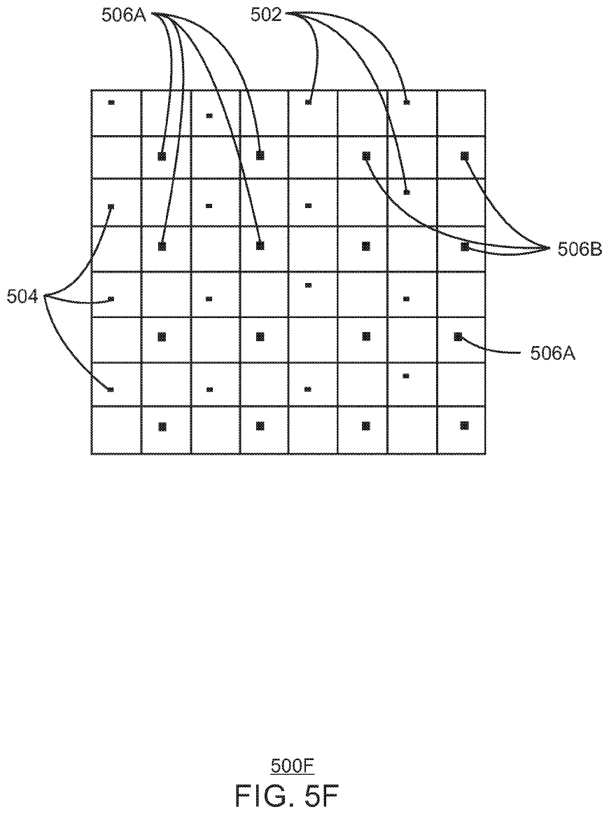

In the diagonally symmetric pattern 100, a checkerboard pattern of data marks 102 and reference marks 104 may be used to encode both data information and reference information, respectively. The diagonally symmetric pattern 100 may be used in a position-based visually significant marking scheme where a certain position, or range of positions, denotes a marking to be used as a reference marking as opposed to a data marking. In some examples, the position of reference marks may correspond to an average of all other possible positions in each dimension or an un-shifted cluster. However, any other suitable property may be used to distinguish between data marks 102 and reference marks 106. The property used may be a color, size, or any other aspect capable of modulating differences that can distinguish reference marks from data marks. An example modulation using size based on the visually significant marking scheme having a diagonally symmetric pattern 100 is shown in FIG. 5 B below. Regardless of the property used, the reference marks 106 may be similar to the data marks 104 and placed into a similar encoding structure using a visually significant marking scheme such that a visual impact of the reference marks 106 is reduced.

After the arrangement of data marks 104 and reference marks 106 are printed onto a surface, the surface may be scanned or imaged for the presence of marks. If the reference marks 106 are detected, then they may be interpreted based on the visually significant marking scheme and the reference information may be used to subsequently localize and/or interpret the data marks 102. Thus, the data marks 104 may be efficiently and accurately interpreted without the use of a reference image or large out-of-band fiducial markings.

As shown using the line of symmetry 108, the example of FIG. 1 is symmetric across one diagonal. Although it is possible that an image could be reflected around such diagonal to produce a similar pattern, it may not be very likely in physical capture scenarios. Thus, the diagonally symmetric pattern 100 may be used among other patterns described below.

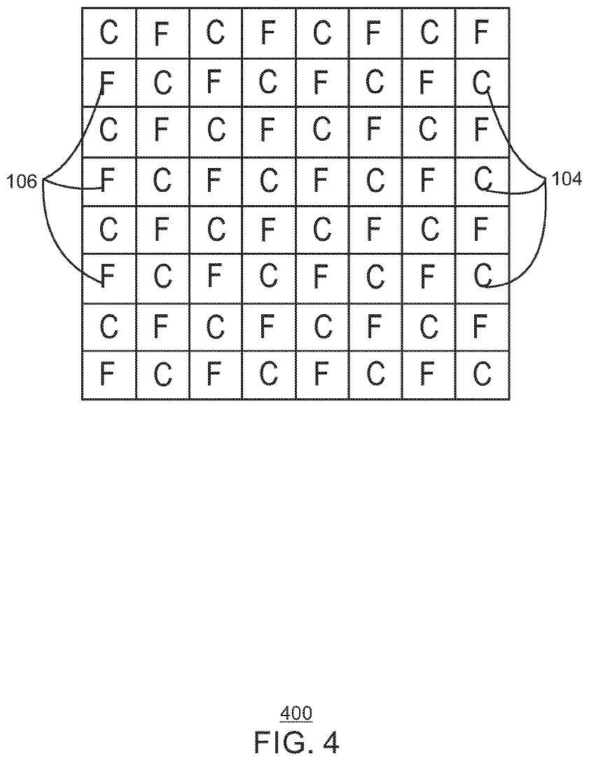

The block diagram of FIG. 1 is not intended to indicate that the example diagonally symmetric pattern 100 is to include all of the components shown in FIG. 1. For example, although a checkerboard pattern is shown, other patterns may be used that may not be regular, or even deterministic. If enough samples of reference marks 106 are present in a scan or image of the surface, the reference marks 106 may together form a signature that may enable more robust interpretation of the data marks 104. Further, the diagonally symmetric pattern 100 may include any number of additional components not shown in FIG. 1, depending on the details of the specific implementation. For example, additional reference marks may be placed in between existing data marks as shown in FIG. 4 below.

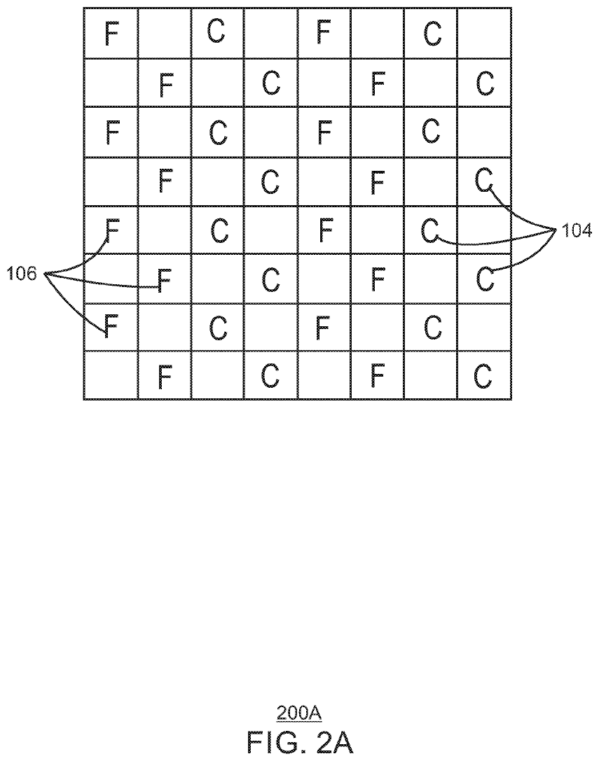

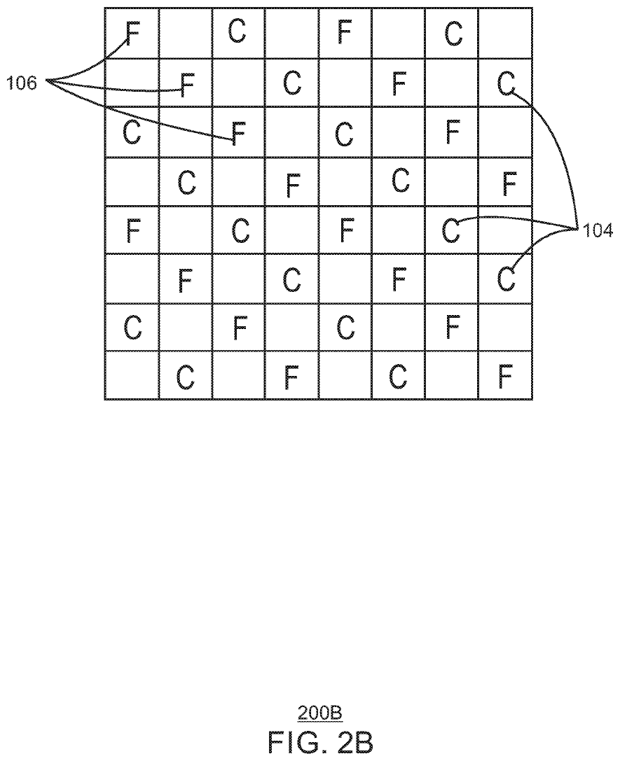

FIG. 2A is a drawing of an example of a visually significant marking scheme having a vertically striped pattern 200A revealing orientation between the two cardinal directions. A visually significant marking scheme having the example vertically striped pattern 200A may be implemented in the computing device 800 or the machine-readable storage medium 900 below.

As shown in FIG. 2A, another checkerboard pattern may also include data marks 104 and reference marks 106. In this example, the vertically striped pattern 200A includes alternating pairs of columns of reference marks 106 and data marks 104. The vertically striped pattern 200A may be used to distinguish between the cardinal directions. For example, the direction of up and down may be distinguished from the directions left and right.

FIG. 2B is a drawing of another example of a visually significant marking scheme having a diagonally striped pattern revealing orientation between the two cardinal directions. The example visually significant marking scheme having the example pattern 200B may be implemented in the computing device 800 or the machine-readable storage medium 900 below.

As shown in FIG. 2B, the example diagonally striped pattern 200B includes another checkerboard pattern that may also include data marks 104 and reference marks 106. The diagonally striped pattern 200B includes alternating diagonals of reference marks 106 and data marks 104. The diagonally striped pattern 200B may also be used to distinguish between the cardinal directions. Again, the direction of up and down may be distinguished from the directions left and right.

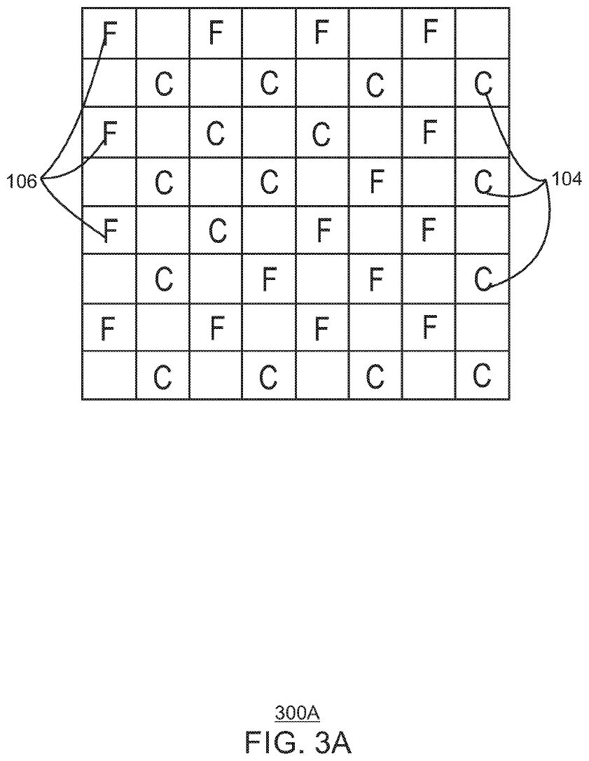

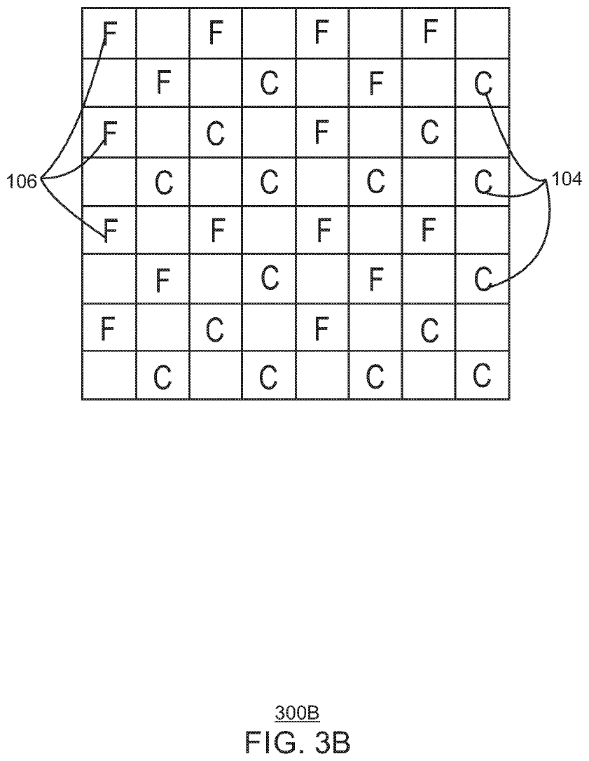

FIG. 3A is a drawing of an example of a visually significant marking scheme having a mixed pattern 300A revealing a more detailed orientation. A visually significant marking scheme with pattern 300A may be implemented in the computing device 800 or the machine-readable storage medium 900 below.

As shown in FIG. 3A, the pattern 300A includes another checkerboard pattern that may also include data marks 104 and reference marks 106. The pattern 300A includes a first row and column of reference marks 106 and a last row and column of data marks 104, with an inner grouping of data marks 104 in the upper-left middle portion and a grouping of reference marks 106 in the lower-left middle portion of the pattern 300A. The pattern 300A may be used to further distinguish directions within the cardinal directions. For example, the direction of up may be distinguished from the direction of down and the direction of left may be distinguished from the direction right. Thus, more detailed orientation may be determined using the visually significant marking scheme 300A than in the patterns of FIGS. 2A and 2B above.

FIG. 3B is a drawing of another example of a visually significant marking scheme having a differently mixed pattern 300B revealing more detailed orientation. A visually significant marking scheme having the differently mixed pattern 300B may be implemented in the computing device 800 or the machine-readable storage medium 900 below.

As shown in FIG. 3B, the differently mixed pattern 300B includes another checkerboard pattern that may also include data marks 104 and reference marks 106. The differently mixed pattern 300B also includes a first row and column of reference marks 106 and a last row and column of data marks 104, but with a mixed inner grouping of data marks 104 and reference marks 106 in the middle portion of the differently mixed pattern 300B. The differently mixed pattern of 300B may also be used to further distinguish directions within the cardinal directions. For example, the direction of up may be distinguished from the direction of down and the direction of left may be distinguished from the direction right. Thus, a more detailed orientation may be determined using the differently mixed pattern 300B.

FIG. 4 is a drawing of an example of a visually significant marking scheme having a capacity-preserving pattern 400. A visually significant marking scheme having the capacity-preserving pattern 400 may be implemented in the computing device 800 or the machine-readable storage medium 900 below.

As shown in FIG. 4, the capacity-preserving pattern 400 may include a pattern that may also include data marks 104 and reference marks 106. The capacity-preserving pattern 400 includes a solid pattern of alternating data marks 104 and reference marks 106. The capacity-preserving pattern 400 may be used to preserve data-carrying capacity. For example, the reference marks 106 may be placed in between data marks 104 such that the number of data marks 104 is doubled. Thus, the same amount of information may be represented in the data marks 104 as if the data marks 104 took up all the marks of the checkerboard patterns discussed above. Additional reference information may also be provided via the additional reference marks 106.

FIG. 5A is a drawing of an example of a data dot pattern 500A with embedded data to be arranged according to a pattern of a visually significant marking scheme. The example data dot pattern 500A may be implemented in the computing device 800 or the machine-readable storage medium 900 below. Again, although included throughout FIGS. 5A-5F for purposes of illustrating relative position, the grid lines shown may not be printed when a corresponding dot pattern using the various visually significant marking schemes described herein is printed onto a surface.

As shown in FIG. 5A, the data dot pattern 500A may include a pattern of data marks modulated using relative position within the cells. For example, a higher position 502 and lower position 504 may be used to encode values of bits. Although relative position is used to encode data marks in data dot pattern 500A, any other suitable property may be used, or a combination thereof. For example, dot size, dot color, or other symbols may be used to distinguish between different values for the data marks.

FIG. 5B is a drawing of an example of a modulated dot pattern 500B positioned according to a visually significant marking scheme. The example dot pattern 500B may be implemented in the computing device 800 or the machine-readable storage medium 900 below.

As shown in FIG. 5B, the modulated dot pattern 500B includes the data dot pattern of FIG. 5A, where additional changes in dot size are used to indicate the presence of reference marks, within the visually significant marking scheme of FIG. 1 above. For example, a higher position 502 and lower position 504 may be used to encode values of bits, and larger size dots may represent reference marks 506. The reference marks 506 are shown centered without any position modulation. If dot position is used to represent data information, then a coordinate system in which the dots may be printed may be detected using the dot size. In some examples, smaller dots may be used instead to represent reference marks. In addition, although dot size is used to distinguish data marks from reference marks in modulated dot pattern 500B, any other suitable property may be used, or a combination thereof. For example, dot color, shift in another direction, or other symbols may be used to distinguish between different data marks. In some examples, the same type of modulation used to encode the data marks may also be used to encode the reference marks. The reference marks could be encoded instead by shifting the dots left or right. In another example, different dot colors could be used to modulate data mark values while an intensity or some other property of the dot colors may be used to encode reference marks.

FIG. 5C is a drawing of an example of a vertically oriented dot pattern arranged according to a visually significant marking scheme having an orientation-revealing pattern that is vertically striped. The example vertically oriented dot pattern 500C may be implemented in the computing device 800 or the machine-readable storage medium 900 below.

As shown in FIG. 5C, the vertically oriented dot pattern 500C includes the data pattern of FIG. 5A, where additional changes in dot size are used to indicate the presence of reference marks 506 according to a visually significant marking scheme having a pattern described in FIG. 2A above. For example, a higher position 502 and lower position 504 may be used to encode values of bits, and larger size dots may represent reference marks 506. Again, in some examples, smaller dots may be used instead to represent reference marks while larger dots may represent data marks. In addition, although dot size is used to distinguish data marks from reference marks in vertically oriented dot pattern 500C, any other suitable property may be used, or a combination thereof. For example, dot color, shift in another direction, or other symbols may be used to distinguish between different data marks. In some examples, the same type of modulation used to encode the data marks may also be used to encode the reference marks.

FIG. 5D is a drawing of an example of a mixed modulated dot pattern 500D arranged according to a visually significant marking scheme having a more detailed orientation-revealing mixed pattern. The example mixed modulated dot pattern 500D may be implemented in the computing device 800 or the machine-readable storage medium 900 below using a visually significant marking scheme with the mixed pattern of FIG. 3B above.

As shown in FIG. 5D, the mixed modulated dot pattern 500D includes data marks arranged according to the pattern of FIG. 5A, where additional changes in dot size are used to indicate the presence of reference marks 506 according to a visually significant marking scheme having the mixed pattern of FIG. 3B above. For example, a higher position 502 and lower position 504 may be used to encode values of bits, and larger size dots may represent reference marks 506. Again, smaller dots may be used instead to represent reference marks while larger dots may represent data marks. In addition, although dot size is used to distinguish data marks from reference marks in mixed modulated dot pattern 500D, any other suitable property may be used, or a combination thereof. For example, dot color, shift in another direction, or other symbols may be used to distinguish between different data marks. In some examples, the same type of modulation used to encode the data marks may also be used to encode the reference marks. In any case, the mixed modulated dot pattern 500D may be used to distinguish between left and right directions and up and down directions.

FIG. 5E is a drawing of an example of a capacity-preserving dot pattern arranged according to a visually significant marking scheme having a capacity-preserving pattern. The example capacity-preserving dot pattern 500E may be implemented in the computing device 800 or the machine-readable storage medium 900 below using a visually significant marking scheme having the capacity-preserving pattern of FIG. 4 above.

As shown in FIG. 5E, the capacity-preserving dot pattern 500E includes data marks arranged according to the pattern of FIG. 5A, where additional changes in dot size are used to indicate the presence of reference marks 506 according to visually significant marking scheme having the capacity-preserving pattern of FIG. 4. For example, a higher position 502 and lower position 504 may be used to encode values of bits, and larger size dots may represent reference marks 506. Again, smaller dots may be used instead to represent reference marks while larger dots may represent data marks. In addition, although dot size is used to distinguish data marks from reference marks in capacity-preserving dot pattern 500E, any other suitable property may be used, or any combination thereof. For example, dot color, shift in another direction, or other symbols may be used to distinguish between different data marks. In some examples, the same type of modulation used to encode the data marks may also be used to encode the reference marks. Using the capacity-preserving dot pattern 500E, additional data information, reference information, or both, may be encoded onto a surface.

FIG. 5F is a drawing of an example of a high resolution dot pattern 500F arranged according to a visually significant marking scheme having more variation to provide higher resolution positional information. A greater variation in the reference marks may be used to provide a higher resolution positional information. The example dot pattern 500F may be implemented in the computing device 800 or the machine-readable storage medium 900 below.

As shown in FIG. 5F, the high resolution dot pattern 500F includes data marks arranged according to the pattern of FIG. 5A, where additional changes in dot size are used to indicate the presence of reference marks 506 that may be used for multiple purposes. For example, a higher position 502 and lower position 504 may be used to encode values of bits, and larger size dots may represent data marks 506. Further, the position of the reference marks can be used to convey further information, such as on which half of the design the dots occur. For instance, reference dots shifted to the left could indicate reference dots occurring on the left side of the design, and references dots shifted to the right could indicate reference dots occurring on the right side of the design. Thus, the reference dots may be used for the purpose of localizing the data dots and for providing information about absolute position. Again, in some examples, smaller dots may be used instead to represent reference marks while larger dots may represent data marks. In addition, although dot size is used to distinguish data marks from reference marks in high resolution dot pattern 500F, any other suitable property may be used, or a combination thereof. For example, dot color, shift in another direction, or other symbols may be used to distinguish between different data marks. In some examples, the same type of modulation used to encode the data marks may also be used to encode the reference marks. Using the high resolution dot pattern 500F, additional data information, reference information, or both, may be encoded onto a surface. In addition, the reference marks may be modulated dynamically based on the local surface that each reference mark is to be printed onto. For example, the modulation may be used to indicate a property of the local surface such as substrate properties, shape, texture, smoothness, conductivity, porosity, reflectivity, and the like. In some examples, multiple sets of reference marks may be included in a visually significant marking scheme. Using multiple sets of reference marks may enable simpler and more robust estimates of reference information. For example, the reference marks may represent absolute positional information. Greater variation in the reference marks may thus be used to provide higher resolution positional information.

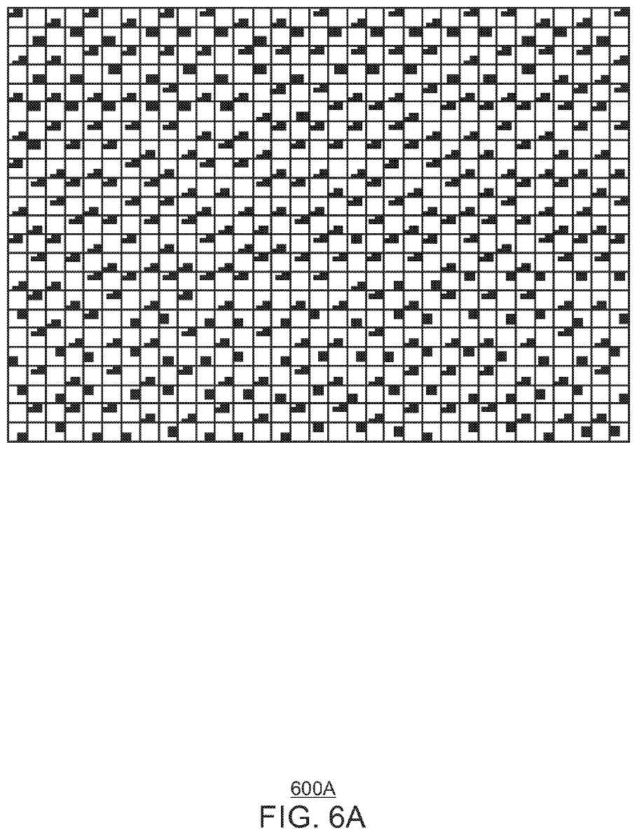

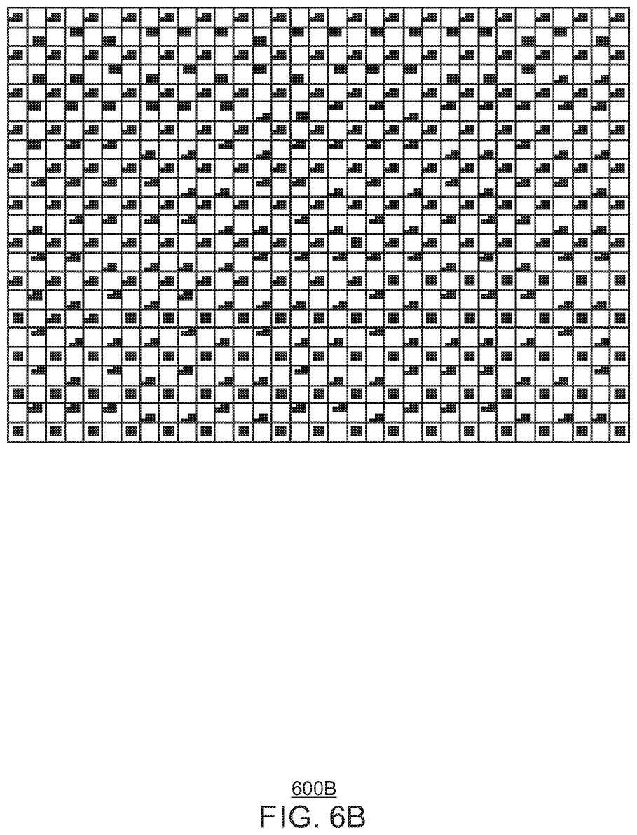

FIG. 6A is a drawing of an example of a clustered-dot halftone 600A with embedded data. The example clustered-dot halftone 600A may be implemented in the computing device 800 or the machine-readable storage medium 900 below.

As shown in FIG. 6A, the clustered-dot halftone 600A may include a pattern of halftone dots modulated using shape and relative position within the cells. For example, each of the halftone dots may be positioned in one of a predetermined number of possible positions within each cell. Although relative position is used to encode data marks in the clustered-dot halftone 600A, any other suitable property may be used, or a combination thereof. In the example of FIG. 6A, the size of the clusters corresponds to the luminance of the area that the clusters represent. At higher resolutions the individual dots may not be seen, but rather the overall proportion of black to white may convey the gray value of the original image the clusters are representing.

FIG. 6B is a drawing of an example of a modulated clustered-dot halftone 600B arranged according to a visually significant marking scheme. The example clustered-dot halftone 600B may be implemented in the computing device 800 or the machine-readable storage medium 900 below using the clustered-dot halftone 600A of FIG. 6A modulated based on the visually significant marking scheme of FIG. 1.

As shown in FIG. 6B, the modulated clustered-dot halftone 600B may include a pattern of halftone dots modulated using relative position within the cells with half of the clustered-dots being unshifted 602. For example, each of the halftone dots may be positioned in one of a predetermined number of possible positions within each cell. Although relative position is used to encode both data marks in the modulated clustered-dot halftone 600B, any other suitable property may be used, or a combination thereof. Thus, when printed, the modulated clustered-dot halftone 600B may appear as a portion of an image while encoding detectable reference data and image data.

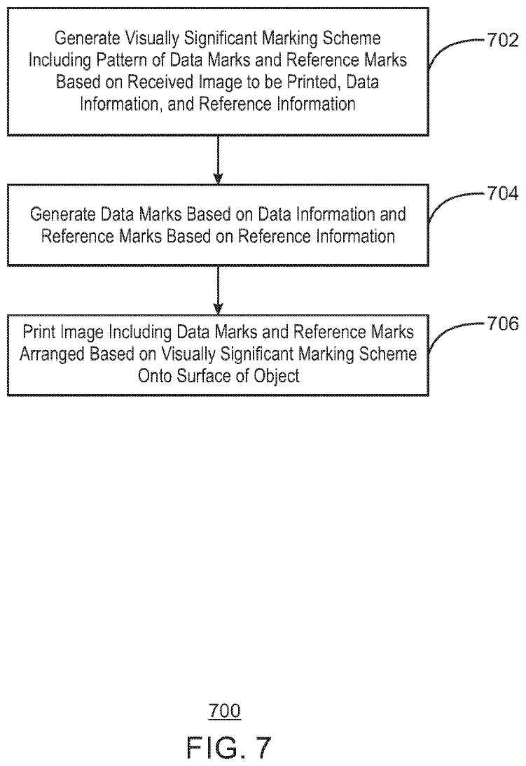

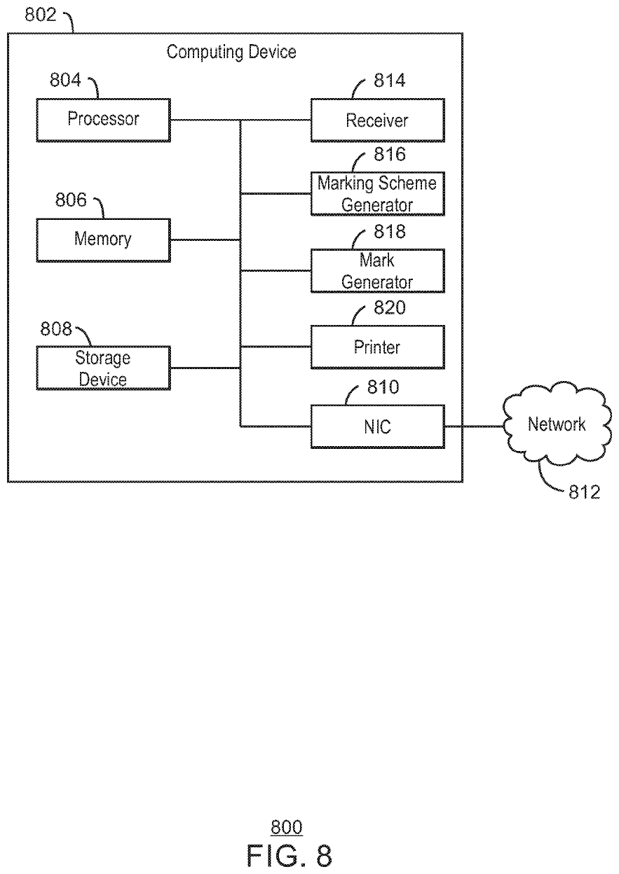

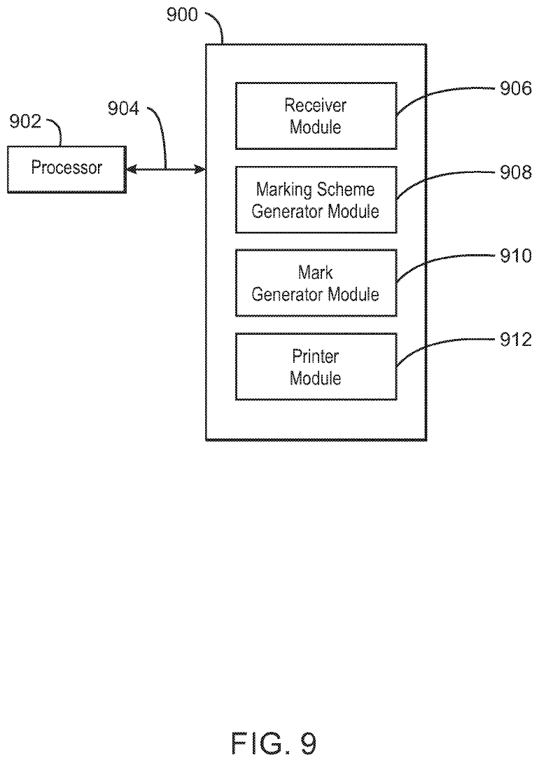

FIG. 7 is a process flow diagram illustrating an example method for printing images with reference marks based on a visually significant marking scheme. The method 700 of FIG. 7 may be implemented using visually significant marking schemes having the example patterns of FIGS. 1, 2A, 2B, 3A, 3B, 4, dot patterns of FIGS. 5B-5F or clustered halftone of FIG. 6B above or the computing device 800 or below. For example, the method may be implemented using processor 802 or the machine-readable storage medium 900 and processor 902 of FIGS. 8 and 9 below.

At block 702, a visually significant marking scheme is generated including a pattern of data marks and reference marks based on a received image to be printed, data information, and reference information. For example, the visually significant marking scheme may be a halftone dot cluster to be printed.

At block 704, data marks are generated based on the data information and the reference marks are generated based on the reference information. For example, states of the data information may be encoded based on a position or a geometric aspect of the data marks. To generate the reference marks, a data mark may be copied and at least one property of the data mark modified. In some examples, a size, a color, a shape, a position, or a rotation of at least one of the reference marks may be dynamically modulated based on a property of a local surface of the surface onto which the reference mark is to be printed.

At block 706 the image including the data marks and the reference marks arranged based on the visually significant marking scheme is printed onto the surface of the object. The image may be printed using ink or any other print media using suitable printing techniques.

It is to be understood that the process diagram of FIG. 7 is not intended to indicate that all of the elements of the method 700 are to be included in every case. Further, any number of additional elements not shown in FIG. 7 may be included in the method 700, depending on the details of the specific implementation. An image of the object including the printed visually significant marking scheme may be received. In some examples, the image may be predetermined, or otherwise constrained. During generation, the reference marks may be determined from the received image, or properties of the surface onto which the visually significant marking scheme is to be printed. If the visually significant marking is received, the reference marks in the printed visually significant marking scheme may be detected. Reference information may be extracted from the reference marks. For example, a grid may be detected using the reference marks. Data information may then be extracted from the data marks based on the extracted reference information. For example, the data marks may be interpreted based on the detected gridlines of the grid. In some examples, the extracted reference information may only be extracted from reference marks adjacent to each data mark.

FIG. 8 is a block diagram of an example computing device 802 to print images with reference marks based on a visually significant marking scheme. The computing device 802 may include a processor 804, memory 806, a machine-readable storage 808, and a network interface 810 to connect computing system 802 to network 812. For example, the network interface 810 may be a network interface card (NIC).

In some examples, the processor 804 may be a main processor that is adapted to execute the stored instructions. Moreover, more than one processor 804 may be employed. Further, the processor 804 may be a single core processor, a multi-core processor, a computing cluster, or any number of other configurations. The processor 804 may be implemented as Complex Instruction Set Computer (CISC) or Reduced Instruction Set Computer (RISC) processors, x86 Instruction set compatible processors, ARMv7 Instruction set compatible processors, multi-core, or any other microprocessor or central processing unit (CPU).

The memory 106 may be one or more memory devices. The memory 106 may be volatile memory or nonvolatile memory. In some examples, the memory 806 may include random access memory (RAM), cache, read only memory (ROM), flash memory, and other memory systems.

The storage 808 is machine-readable storage and may include volatile and nonvolatile memory. In some examples, the machine-readable storage 808 may be electronic, magnetic, optical, or other physical storage device that stores executable instructions (e.g., code, logic). Thus, the machine-readable storage 808 medium may be, for example, RAM, an Electrically-Erasable Programmable Read-Only Memory (EEPROM), a storage drive such as a hard drive or solid state drive (SSD), an optical disc, and the like. The storage 808 may also include storage or memory external to the computing device 802. Moreover, as described below, the machine-readable storage medium 808 may be encoded with executable instructions (e.g., executed by the one or more processors 804) for prioritizing data. For example, the machine-readable storage medium 808 may be encoded with executable instructions for printing images with reference marks based on a visually significant marking scheme.

In some examples, a network interface 810 (e.g., a network interface card or NIC) may couple the computing system 802 to a network 812. For example, the network interface 810 may connect computing system 802 to a local network 812, a virtual private network (VPN), or the Internet. In some examples, the network interface 810 may include an Ethernet controller.

The computing device 802 may also include a receiver 814, a marking scheme generator 816, a mark generator 818, and a printer 820. The receiver 814 may receive an image to be printed onto a surface, data information, and reference information. The marking scheme generator 816 may generate a visually significant marking scheme including a pattern of data marks and a reference mark based on the image, the data information, and the reference information. For example, the data marks may include dots with different relative positions and the reference marks may include dots with a different size. The arrangement of the reference marks may reveal geometric aspects or cardinal orientations of the visually significant marking scheme relative to the surface. The mark generator 818 may generate a plurality of data marks based on the data information and reference marks based on the reference information. For example, the mark generator 818 may generate data marks by modulating the data marks to encode values. The modulated property may be color, size, relative position, or any other suitable property of the data marks. The appearance of the reference marks may be generated based on the appearance of the data mark. For example, the mark generator 818 may modulate a property of a data mark to generate the reference marks. In some examples, the mark generator 818 may additionally dynamically modulate a reference mark based on a property of a local surface onto which the reference mark is to be printed. The printer 820 may print the image including the data marks and the reference marks arranged according to the visually significant marking scheme on the surface.

The receiver 814, the marking scheme generator 816, the mark generator 818 may be instructions (e.g., code, logic, and the like) stored in the machine-readable storage 808 and executed by the processor 804 or other processor to direct the computing device 800 to implement the aforementioned actions. An application-specific integrated circuit (ASIC) may also be employed. In other words, one or more ASICs may be customized for the aforementioned actions implemented via the receiver 814, locator 816, and change detector 818.

The storage 808 may include images to be printed, stored visually significant marking schemes, data information, and reference information.

The block diagram of FIG. 8 is not intended to indicate that the computing device 802 is to include all of the components shown in FIG. 8. Further, the computing device 802 may include any number of additional components not shown in FIG. 8, depending on the details of the specific implementation.

FIG. 9 is a block diagram showing a tangible, non-transitory, machine-readable storage medium that stores code to direct a processor to print images with reference marks based on a visually significant marking scheme. The machine-readable medium is generally referred to by the reference number 900. The machine-readable medium 900 may include RAM, a hard disk drive, an array of hard disk drives, an optical drive, an array of optical drives, a non-volatile memory, a flash drive, a digital versatile disk (DVD), or a compact disk (CD), among others. The machine-readable storage medium 900 may be accessed by a processor 902 over a bus 904. The processor 902 may be a processor of a computing device, such as the processor 804 of FIG. 8. In some examples, the processor 902 may be a field-programmable gate array (FPGA) processor and/or an ASIC processor. Furthermore, as indicated, the machine-readable medium 900 may include code configured to perform the methods and techniques described herein. Indeed, the various logic components discussed herein may be stored on the machine-readable medium 900. Portions 906, 908, and 910 of the machine-readable storage medium 900 may include receiver code, locator code, and change detector code, respectively, which may be executable code (machine readable instructions) that direct a processor or controller in performing the techniques discussed with respect to the preceding figures.

Indeed, the various logic (e.g., instructions, code) components discussed herein may be stored on the tangible, non-transitory machine-readable medium 900 as indicated in FIG. 9. For example, the machine-readable medium 900 may include the receiver module 906 including instructions that, when executed by a processor, direct the processor or a computing device to receive an image to be printed onto a surface, data information, and reference information. The machine-readable medium 900 may also include marking scheme generator module 908 that includes instructions that, when executed by a processor, direct the processor or a computing device to generate a visually significant marking scheme a pattern of data marks and reference marks based on the data information and the reference information. For example, the marking scheme generator module 908 may direct the processor or computing device to specify a position of the subset of the plurality of reference marks based on an average of possible positions of the data marks in each dimension. In some examples, the marking scheme generator module 908 may direct the processor or computing device to arrange at least a subset of the reference marks in between the data marks in the visually significant marking scheme to preserve a data-carrying capacity of the data marks. The machine-readable medium 900 may further include the mark generator module 910 including instructions that, when executed by a processor, direct the processor or a computing device to generate data marks based on the data information and reference marks based on the reference information. The machine-readable medium 900 may further include a printer module 912 including instructions that, when executed by a processor, direct the processor or a computing device to print the image including the reference marks and the data marks arranged according to the visually significant marking scheme on the object.

Although shown as contiguous blocks, the logic components may be stored in any order or configuration. For example, if the machine-readable medium 900 is a hard drive, the logic components may be stored in non-contiguous, or even overlapping, sectors. Further, the machine-readable medium 900 may include any number of additional components not shown in FIG. 9, depending on the details of the specific implementation. For example, the machine-readable medium 900 may include a data information extractor module (not shown) that may include instructions that, when executed by a processor, direct the processor or a computing device to receive an image of the object including the printed visually significant marking scheme. The data information extractor module may direct the processor or a computing device to detect a presence of reference marks in the image. The data information extractor module may also direct the processor or a computing device to extract reference information from the reference marks. The data information extractor module may also direct the processor or a computing device to extract data information from the data marks based on the extracted reference information.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the true spirit and scope of the appended claims.

What is claimed is:

1. A method comprising:
generating a visually significant marking scheme comprising a pattern of data marks and reference marks based on a received image to be printed, data information, and reference information;
generating the data marks based on the data information and the reference marks based on the reference information; and
printing the image comprising the data marks and the reference marks arranged based on the visually significant marking scheme onto the surface of the object.

2. The method of claim 1, comprising dynamically modulating a size, a color, a shape, a position, or a rotation of at least one of the reference marks based on a property of a local surface of the surface onto which the reference mark is to be printed.

3. The method of claim 1, wherein generating the data marks comprises encoding states of the data information based on a position or a geometric aspect of the data marks.

4. The method of claim 1, wherein generating the reference marks comprises copying a data mark and modifying at least one property of the data mark.

5. The method of claim 1, wherein the visually significant marking scheme comprises a clustered-dot halftone.

6. The method of claim 1, comprising:
receiving an image of the object comprising the printed visually significant marking scheme;
detecting the reference marks in the printed visually significant marking scheme;
extracting reference information from the reference marks; and
extracting data information from the data marks based on the extracted reference information.

7. The method of claim 6, wherein the extracted reference information is only extracted from reference marks adjacent to each data mark.

8. An apparatus comprising:
a receiver to receive an image to be printed onto a surface, data information, and reference information;
a scheme generator to generate a visually significant marking scheme comprising a pattern of data marks and a reference mark based on the image, the data information, and the reference information;
a mark generator to generate a plurality of data marks based on the data information and reference marks based on the reference information; and
a printer to print the image comprising the data marks and the reference marks arranged according to the visually significant marking scheme on the surface.

9. The apparatus of claim 8, wherein the data marks comprise dots with different relative positions and the reference marks comprise dots with a different size.

10. The apparatus of claim 8, wherein the arrangement of the reference marks reveals a geometric aspect or cardinal orientations of the visually significant marking scheme relative to the surface.

11. The apparatus of claim 8, wherein the mark generator is to dynamically modulate a reference mark based on a property of a local surface of the surface onto which the reference mark is to be printed.

12. A non-transitory machine-readable storage medium encoded with instructions executable by a processor, the machine-readable storage medium comprising instructions to:
receive an image to be printed onto a surface, data information, and reference information;
generate a visually significant marking scheme comprising a pattern of data marks and reference marks based on the data information and the reference information;
generate data marks based on the data information and reference marks based on the reference information; and
print the image comprising the reference marks and the data marks arranged according to the visually significant marking scheme on the object.

13. The non-transitory machine-readable storage medium of claim 12, comprising instructions to specify a position of the subset of the reference marks based on an average of possible positions of the data marks in each dimension.

14. The non-transitory machine-readable storage medium of claim 12, comprising instructions to arrange at least a subset of the reference marks in between the data marks in the visually significant marking scheme to preserve a data-carrying capacity of the data marks.

15. The non-transitory machine-readable storage medium of claim 12, comprising instructions to:
receive an image of the object comprising the printed visually significant marking scheme;
detect a presence of reference marks in the image;
extract reference information from the reference marks; and
extract data information from the data marks based on the extracted reference information.
